(19) United States
(12) Patent Application Publication
(10) Pub. No.: US 2009/0286198 A1
(43) Pub. Date: Nov. 19, 2009

(54) HAND HELD DENTAL INSTRUMENT WITH FILTRATION DEVICE

(75) Inventors: Yves Bonin, Araches La Frasse (FR); Fabrice Lamour, Passy (FR)

Correspondence Address: WILLIAM H. EILBERG, 316 CALIFORNIA AVE. #785, RENO, NV, 89509, US

(73) Assignee: ANTHOGYR, Sallanches (FR)

(21) Appl. No.: 12/442,406

(22) PCT Filed: Sep. 24, 2007
(86) PCT No.: PCT/IB2007/053873

§ 371 Date: Mar. 23, 2009

(30) Foreign Application Priority Data
Sep. 25, 2006 (FR) 06 53934

(51) Int. Cl. A61C 17/02

(52) U.S. Cl. 433/82

(57) ABSTRACT

A hand-held dental instrument is used for supporting a working tool and driving it according to a relative movement, including at least first fluid conveying means for conveying fluids through a body from the proximal end of the body towards fluid projection means. The first fluid conveying means include an upstream fluid conveying channel, a downstream fluid conveying channel, as well as a fluid collection radial chamber provided in the body between the upstream fluid conveying channel and the downstream fluid conveying channel. A filtration pin is mounted in the fluid collection radial chamber with a clearance allowing for the through-flow and the filtration of the fluids between the upstream fluid conveying channel and the downstream fluid conveying channel.

### TECHNICAL FIELD OF THE INVENTION

The present invention concerns hand held instruments used, inter alia, by dentists and oral surgeons. The invention concerns more specifically hand held dental instruments for supporting a working tool and driving it in relative movement to operate on or treat a patient.

During operation, it is sometimes necessary to use fluids such as air or water sprayed under pressure to cool the working tool and/or to clean and cool the working area and its vicinity. Hand held dental instruments are therefore connected to a central supply via a feed hose feeding the fluid or fluids under pressure.

Thus hand held dental instruments include internal and/or external passages for conveying the fluid or fluids. These passages have a very small section and there is therefore a risk of them becoming blocked.

It is therefore necessary to filter the fluid or fluids so that they do not contain any polluting particles liable to block the passages of the hand held dental instrument.

A first solution has consisted until now of filtering the fluid or fluids after they leave the central supply. This is the case in particular of the documents U.S. Pat. No. 5,556,279 and U.S. Pat. No. 5,630,939, which propose filtration devices intended to be mounted on the fluid feed pipe between the hand held instrument and the central supply.

However, between these filtration devices and the hand held dental instrument, there are many components constituting the fluid feed path (pipes, fluid-tight connecting areas, . . . ) and there is the risk of particles produced during use of the hand held dental instrument not being filtered, entailing the risk of blocking the passages of the hand held dental instrument. This applies in particular to numerous O-ring seals, in particular in the vicinity of the area for connecting the hand held dental instrument to the feed pipe coming from the central supply. Indeed, successive connections and disconnections produce shear and compression stresses in the O-ring seals and, through abrasion, cause the detachment of polluting particles based on elastomers.

In the absence of a filtration device downstream of the connection between the feed hose and the hand held dental instrument, these particles are entrained by the fluid or fluids and enter the passages of the hand held dental instrument, and if they do not block them, are projected into the mouth of the patient in the vicinity of the working area, causing a critical lack of hygiene.

Thus use has been made of filtration devices mounted directly at the proximal end of the hand held dental instruments, as is the case in the documents EP 1 279 377 and U.S. Pat. No. 6,106,287, for example. There nevertheless still remains a fluid-tight connecting area downstream of these filtration devices and that is also liable to produce polluting particles through successive disconnections/connections of the hand held dental instrument. Moreover, the overall size of these filtration devices is added to the overall size of the hand held dental instrument. This kind of solution is an impediment to the practitioner during operations, there being very little space available for him to work. Such devices do not provide a satisfactory response to the requirements and expectations of practitioners.

Filtration devices integrated directly into the handle of the hand held dental instrument were then proposed, as in the document EP 1 234 548, which uses a cylindrical radial filtration cartridge. This kind of solution necessitates making the handle of the hand held dental instrument longer in order to house the filtration cartridge in it, again increasing the overall size of the hand held dental instrument.

Moreover, all the filtration devices of the documents U.S. Pat. No. 5,556,279, U.S. Pat. No. 5,630,939, U.S. Pat. No. 6,106,287, EP 1 234 548 and EP 1 279 377 function according to the principle of filtration by screening. Filtration by screening is effected by means of a filter with meshes of particular passage section. Particles larger than the passage section of the meshes are retained by the filter while others pass through. The efficacy of the filter is therefore very limited.

Furthermore, because of the accumulation of the retained particles on the filter, filtration by screening induces head losses that can be prejudicial. It is therefore necessary periodically to replace the filters and cylindrical filter cartridges, which leads to a regular waste of time, dismantling and reassembly of the device that are often lengthy and laborious, and the purchase of consumable supplies of non-negligible cost. Because of the long dismantling and reassembly times required by the operation of changing the filters and cylindrical filter cartridges, the practitioner is tempted to delay changing them. This results in a lack of hygiene and in notorious head loss in the fluid passages, the filter or the cylindrical filter cartridge being blocked more than is reasonable.

To remedy these drawbacks, the document U.S. Pat. No. 6,196,841 proposes a plurality of openings provided in a substantially cylindrical section of the handle of the hand held dental instrument. Once again there is filtration by screening with the size of the openings determining the filtration properties, with limited performances.

Moreover, producing this plurality of openings proves fastidious and costly because of the large number of openings of precise size that it is necessary to produce.

### STATEMENT OF THE INVENTION

A first problem addressed by the invention is to provide simply and at low cost reliable means for filtering the fluid or fluids downstream of the connecting area between the hand held dental instrument and the fluid feed hose, which filtration means must be easily dismantled and cleaned by a qualified technician or by the user himself.

Simultaneously, the present invention aims to provide means for filtering the fluid or fluids in a hand held dental instrument that necessitate no consumables such as a filter cartridge, which avoid the accumulation of impurities in the vicinity of the filtration area, in order not to cause head losses, and which have a very small volume, in order not to increase the overall size of the hand held dental instrument and not to impede the work of the practitioner.

To achieve the above and other objects, the invention proposes a hand held dental instrument for carrying a working tool and driving it in relative movement, including:
a body with a proximal body end with an internal connecting bore and a distal body end, adapted to be connected at its proximal end to driving means and to fluid feed means for conveying at least one fluid,
a head connected to the distal body end, able to carry the working tool, and including means for spraying fluids in the direction of the working area of the tool,
at least first fluids conveying means, for conveying the fluids through the body from the proximal end of the body and transmitting them to the fluids spraying means of the head, including an upstream fluids conveying channel, a downstream fluids conveying channel, and a fluids collecting chamber in the body, between the upstream fluids conveying channel and the downstream fluids conveying channel,

wherein:
the fluids collecting chamber is radial,
a filtration piece is mounted in the radial fluids collecting chamber with a clearance to allow the passage of and to filter fluids between the upstream fluids conveying channel and the downstream fluids conveying channel.

This kind of hand held dental instrument includes a filtration device that is integrated directly into it, performing filtration as far downstream as possible on the path taken by the fluid.

Filtering is effected for the most part according to a principle of filtration by inertia, more efficient than filtration only by screening and not necessitating the use of consumables such as filters or filter cartridges. There is no addition to the overall size liable to impede the practitioner. Furthermore, it is necessary only to provide a single radial fluids collecting chamber and an attached filtration piece, which proves relatively uncostly.

Preferably, it can be provided that:
the upstream fluids conveying channel extends radially from the internal connecting bore of the body to the radial fluids collecting chamber,
the downstream fluids conveying channel extends from the radial fluids collecting chamber to the distal end of the body.

Thus there is provision for a further filtering by inertia effect on the upstream side of the radial fluids collecting chamber, in the internal connecting bore.

The fluids transmitted to the hand held dental instrument initially flow along the longitudinal axis of the internal bore of the body connection. In order to enter the fluids conveying channels, the fluids have to follow a path including a 90° bifurcation. Because of their size and their weight, polluting particles, such as seal fragments, cannot make the sudden change of direction, will continue on a course substantially parallel to the longitudinal axis of the internal connecting bore, and will not accumulate in the vicinity of the filtration area. The fluid flowing in the longitudinal direction of the internal connecting bore of the body is therefore filtered laterally. The flow and turbulences in the vicinity of the lateral filtration area expel any polluting particle that might accumulate in the vicinity of the filtration area. This avoids head losses during use of the hand held dental instrument.

The filtration piece advantageously has an exterior shape substantially complementary to the interior shape of the radial fluids collecting chamber, making it easier to determine and control the fluid passage section in the radial fluids collecting chamber, in order to control the fluid flowrate.

Preferably, it can be provided that:
the radial fluids collecting chamber includes a circular section radial blind bore, produced in the body and opening onto the exterior surface of the body, with a back wall terminating in the near vicinity of the internal connecting bore of the body,
the upstream fluids conveying channel extends radially from the internal connecting bore of the body to the back wall of the radial fluids collecting chamber.

The radial fluids collecting chamber is therefore easy to produce by means of a tool moving radially towards the body of the hand held dental instrument. This provides excellent accessibility for the tool, which greatly facilitates the production of the radial fluids collecting chamber and reduces its manufacturing cost.

Because the back wall of the radial fluids collecting chamber terminates in the near vicinity of the internal connecting bore of the body, the upstream fluids conducting channel extends a very short distance from the internal connecting bore of the proximal section to the back wall of the radial fluids collecting chamber. During filtering, impurities will therefore not tend to accumulate in the upstream fluid conducting channel, but to remain in the internal connecting bore of the body.

This greatly simplifies cleaning the hand held dental instrument: after disconnecting the feed hose from the hand held dental instrument, the practitioner has only to direct a jet of cleaning fluid into the internal connecting bore of the body in order to remove all the polluting particles that may have accumulated therein. Cleaning the hand held dental instrument does not necessitate long and fastidious dismantling and can be carried out very regularly without a notorious waste of the practitioner's time.

Preferably, it can be provided that:
the filtration piece includes a distal end face and a circular section cylindrical distal filtration section, the outside diameter of the cylindrical distal filtration section being less than the inside diameter of the radial fluids collecting chamber,
the filtration piece includes a circular section cylindrical proximal fixing section with a proximal end face the outside diameter of which is substantially equal to the inside diameter of the radial fluids collecting chamber, intended to fix the filtration piece in the radial fluids collecting chamber and to close the radial fluids collecting chamber.

This kind of filtration piece is simple and of relatively low cost to produce.

The filtration piece advantageously includes, in the vicinity of its distal end face:
a peripheral flange with an outside diameter substantially equal to the inside diameter of the radial fluids collecting chamber,
at least one axial groove provided at the periphery of the flange.

The peripheral flange with its outside diameter substantially equal to the diameter of the radial fluids collecting chamber facilitates centering of the filtration piece in the chamber, which facilitates mounting the filtration piece. Moreover, depending on the size of their section, the axial grooves can contribute to filtration, for a filtration by screening.

The filtration piece is preferably fixed in the radial fluids collecting chamber with an axial clearance between its distal end face and the back wall of the radial blind bore of the radial fluids collecting chamber, the axial clearance enabling passage of and filtering the fluids between the upstream fluids conveying channel and the downstream fluids conveying channel.

Thus filtering is effected, on the one hand, by the axial clearance between the filtration piece and the back wall of the blind bore of the radial fluids collecting chamber and on the other hand by the difference in diameter between the cylindrical distal filtration section of the filtration piece and the blind cylindrical bore of the radial fluids collecting chamber. This significantly improves the reliability of filtration.

Preferably, it can be provided that:
the distal end face includes at least one groove opening onto the exterior wall of the cylindrical distal filtration section,
the filtration piece is fixed in the radial fluids collecting chamber with the distal end face abutted against the back wall of the radial blind bore of the radial fluids collecting chamber.

Thus the filtration piece can be inserted into the radial fluids collecting chamber until its distal end face abuts against the back wall of the blind bore of the radial fluids collecting chamber. Depending on the size of the section of the grooves, the grooves can, through filtration by screening, contribute to filtration.

The filtration piece is advantageously driven into the radial blind bore of the radial fluids collecting chamber with the cylindrical proximal fixing section of the filtration piece a tight fit in the radial blind bore of the radial fluids collecting chamber.

Mounting the filtration piece therefore proves simple and fast. If required, it can be mounted tight so that it cannot be demounted and lost by a user. The filtration piece can nevertheless be removed by a qualified technician provided with the appropriate tools.

Preferably, it can be provided that:
the radial blind bore of the radial fluids collecting chamber has an internal thread over at least part of its length,
the cylindrical proximal fixing section of the filtration piece includes an external thread,
the proximal end face of the cylindrical proximal fixing section of the filtration piece includes a screwing imprint.

The filtration piece is therefore simple and fast to fit. This kind of filtration piece furthermore proves easily demountable by any person having a screwdriver matching the screwing imprint. The external thread of the proximal fixing section can be indexed so that the filtration piece is mounted in the radial fluids collecting chamber leaving the same axial clearance between the distal end face of the filtration piece and the back wall of the radial blind bore of the radial fluids collecting chamber.

### BRIEF DESCRIPTION OF THE DRAWINGS

Other objects, features and advantages of the present invention will emerge from the following description of particular embodiments, given with reference to the appended figures, in which:

FIG. 1 is a view in partial section of a first embodiment of a hand held dental instrument of the invention;

FIG. 2 is a detail view of FIG. 1;

FIG. 3 is a view of the embodiment of the filtration piece used in FIGS. 1 and 2;

FIG. 4 is a detail view in section of a second embodiment of a hand held dental instrument of the invention;

FIG. 5 is a perspective view of the embodiment of the filtration piece used in FIG. 4;

FIGS. 6 to 11 illustrate other embodiments of filtration pieces that can be used with one or the other of the embodiments of the hand held dental instrument illustrated in FIGS. 1 and 4.

### DESCRIPTION OF THE PREFERRED EMBODIMENTS

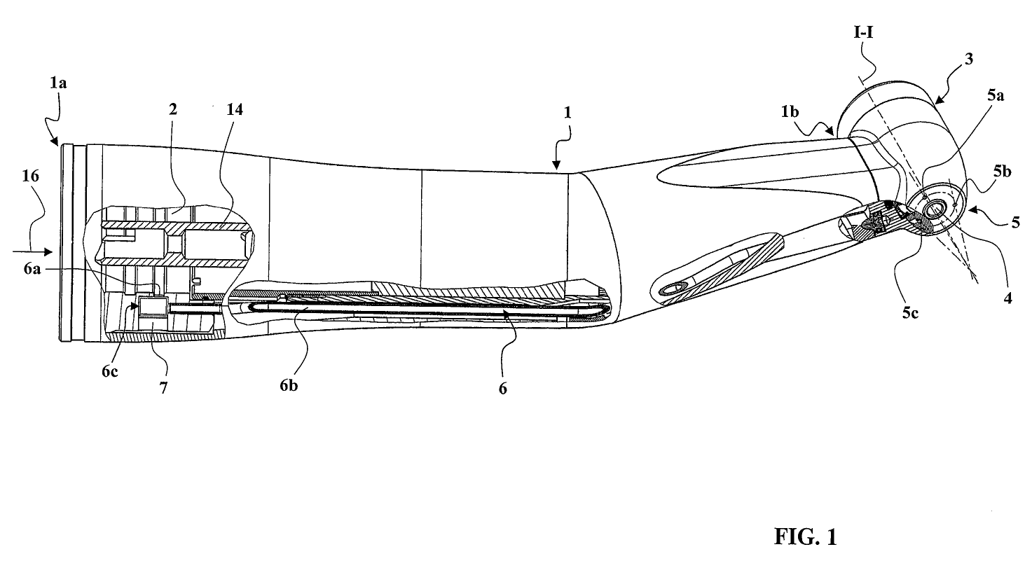

FIG. 1 represents a first embodiment of a hand held dental instrument of the invention. The hand held dental instrument includes:
a body 1, with a proximal end 1a of the body 1 having an internal connecting bore 2 and with a distal end 1b of the body 1, adapted to be connected at its proximal end 1a to driving means and to fluids feed means (not represented),
a head 3, connected to the distal end 1b of the body 1, adapted to carry the working tool (not represented) in a chuck 4, and including means 5 for spraying fluids in the direction of the working area of the tool,
first fluids conveying means 6, for conveying fluids through the body 1 from the proximal end 1a of the body 1 and to transmit them to the fluids spraying means 5 of the head 3.

In the embodiment illustrated in FIG. 1, the fluids spraying means 5 include three spray nozzles 5a, 5b and 5c each generating an axial jet of fluid.

The first fluids conveying means 6 include an upstream fluids conveying channel 6a, a downstream fluids conveying channel 6b and a radial fluids collecting chamber 6c in the body 1, between the upstream fluids conveying channel 6a and the downstream fluids conveying channel 6b. A filtration piece 7 is fitted into the radial fluids collecting chamber 6c with a clearance that enables passage of and filters fluids between the upstream fluids conveying channel 6a and the downstream fluids conveying channel 6b.

The upstream fluids conveying channel 6a extends radially from the internal connecting bore 2 of the body 1 to the radial fluids collecting chamber 6c, while the downstream fluids conveying channel 6b extends from the radial fluids collecting chamber 6c to the distal end 1b of the body 1.

There is no detachable connecting area downstream of the radial fluids collecting chamber 6c in which the fluid is filtered.

The filtration piece 7 has an external shape substantially complementary to the internal shape of the radial fluids collecting chamber 6c except for a clearance.

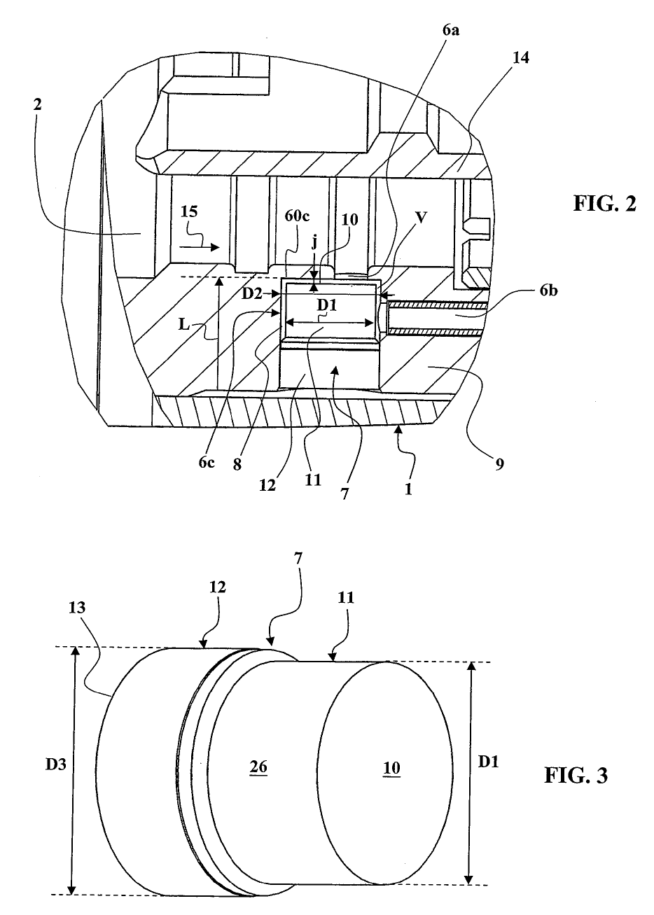

It is seen more particularly in the detail view of FIG. 2 that the radial fluids collecting chamber 6c includes a circular section radial blind bore 8, produced in the body 1 and opening onto the exterior surface of a connecting part 9 in which the internal connecting bore 2 is formed. The radial fluids connecting chamber 6c includes a back wall 60c terminating in the near vicinity of the internal connecting bore 2 of the body 1. The upstream fluids conveying channel 6a extends radially from the internal connecting bore 2 of the body 1 to the back wall 60c of the radial fluids connecting chamber 6c.

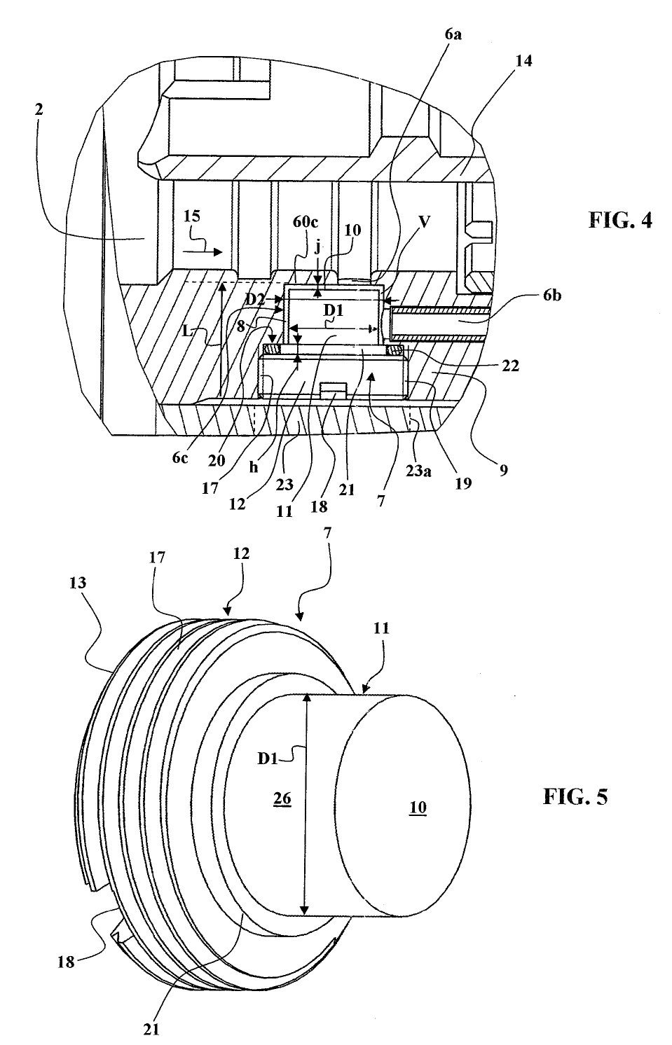

The filtration piece 7 used in the embodiment illustrated in FIGS. 1 and 2 is represented in more detail in FIG. 3. This filtration piece 7 has a distal end face 10 and a circular section cylindrical distal filtration section 11. As can be seen in FIG. 2, the outside diameter D1 of the circular section cylindrical distal filtration section 11 is less than the inside diameter D2 of the radial fluids collecting chamber 6c. The filtration piece 7 also has a circular section cylindrical proximal fixing section 12 with a proximal end face 13, the outside diameter D3 of which is substantially equal to the inside diameter D2 of the radial fluids collecting chamber 6c in the vicinity of the exterior surface of the connecting part 9. The cylindrical proximal fixing section 12 fixes the filtration piece 7 in the radial fluids collecting chamber 6c and closes the radial fluids connecting chamber 6c.

When the hand held dental instrument illustrated in FIGS. 1 and 2 is used, its proximal end 1a is connected to driving means and to fluids feed means (not represented). The driving means drive the drive shaft 14 in rotation to drive the working tool in the chuck 4 with a relative movement. The relative movement of the working tool is effected along the longitudinal axis I-I of the chuck 4.

A fluid under pressure is fed into the internal connecting bore 2. To leave the internal connecting bore 2, the fluid is obliged to exit radially via the upstream fluids conveying channel 6a.

Polluting particles entrained by the fluid, generally of higher density than the fluid, will be incapable of following the flow at the sudden change of flow direction and will remain in the internal connecting bore.

The fluid then enters the radial fluids collecting chamber 6c and escapes from it via the downstream fluids conveying channel 6b.

The filtration piece 7 is fixed in the radial fluids collecting chamber 6c with a small axial clearance j (FIG. 2) between its distal end face 10 and the back wall 60c of the radial blind bore 8 of the radial fluids collecting chamber 6c. The axial clearance j is small compared to the diameter of the upstream fluids conveying channel 6a. The axial clearance j therefore enables passage of the fluid between the upstream fluids conveying channel 6a and the downstream fluids conveying channel 6b.

As it passes through the radial fluids collecting chamber, the fluid suffers a number of changes of flow direction that constitute as many inertial filtration sites. The polluting particles are sprayed against the filtration piece 7 or against the walls of the radial fluids collecting chamber, and stick thereto.

Depending on the clearance j, complementary filtration by screening can be induced by preventing particles of more or less big size from entering the available volume V of the radial fluids collecting chamber 6c.

The fluid then finally passes through the first fluids conveying means 6 through the body 1 to be transmitted to the fluid spraying means 5 of the head 3.

The upstream fluids conveying channel 6a has a large diameter so as not to induce head losses.

Because of the very short length of the upstream fluids conveying channel 6a, the distal end face 10 induces turbulences in and as far as the mouth of the upstream fluids conveying channel 6a, increasing the filtration by inertial effect during radial filtering from the connecting bore 2 to the fluids collecting chamber 6c. Virtually all, or even all, polluting particles remain in the internal connecting bore 2. Even if a polluting particle is located in the immediate vicinity of the mouth of the upstream fluids conveying channel 6a, it will be driven away from the mouth of the upstream fluids conveying channel 6a on the one hand by the turbulences and on the other hand by the flow in the internal connecting bore 2, the direction whereof is represented by the arrow 15.

After using the hand held dental instrument, its proximal end 1a is disconnected from the driving means and the fluids feed means (not represented). The hand held dental instrument is then in the configuration illustrated in FIG. 1 in which the user can easily access the internal connecting bore 2 in the axial direction represented by the arrow 16. The internal connecting bore 2 contains virtually all the polluting particles, and in particular the larger particles. The user can then easily introduce a jet of cleaning fluid in order to remove all the polluting particles that have accumulated in the internal connecting bore 2. The hand held dental instrument is then ready to be used again. There is therefore no need to remove anything at all to clean the filter means of the hand held dental instrument of the invention. The cleaning operation is therefore quick and simple.

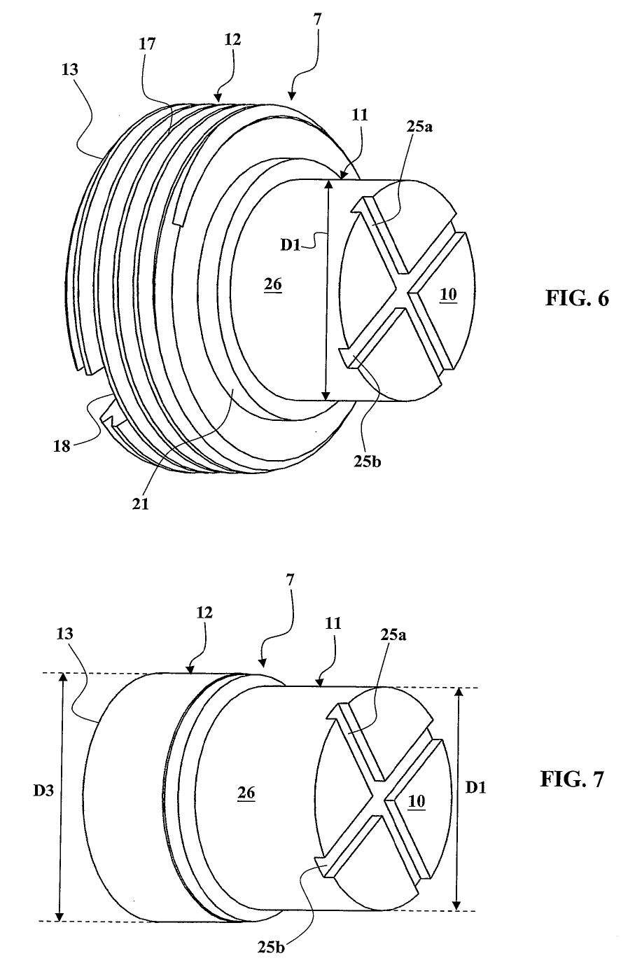

The mode of operation of the hand held dental instrument illustrated in FIGS. 1 and 2 is identical to that of the embodiment of the hand held dental instrument illustrated in FIG. 4.

The embodiment of the hand held dental instrument illustrated in FIG. 4 differs from the preceding one in that it includes a different filtration piece 7.

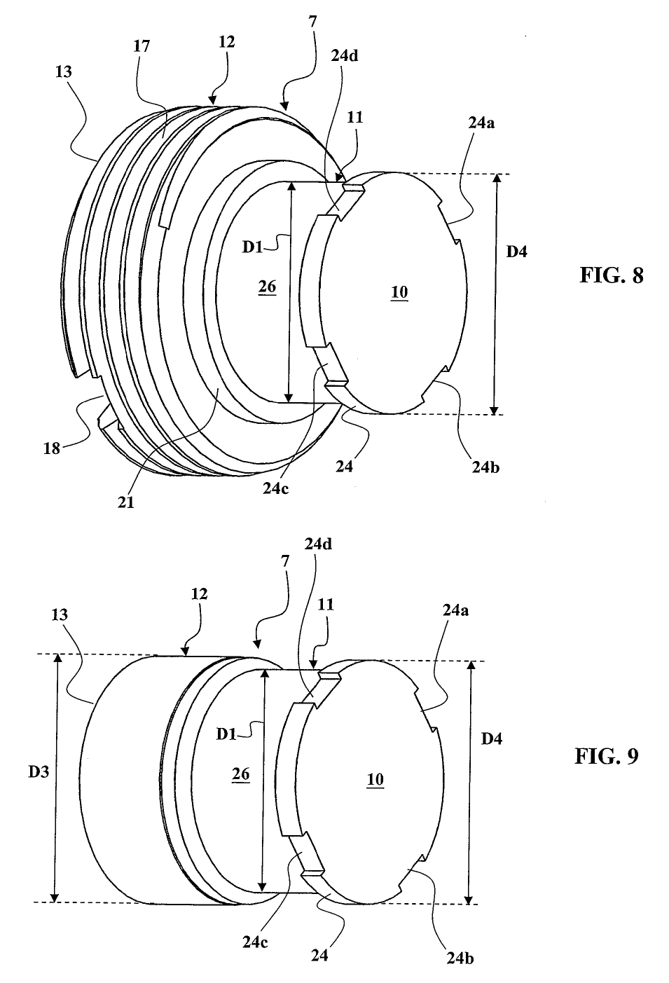

This filtration piece 7 is represented in more detail in FIG. 5. It includes a cylindrical proximal fixing section 12 including an external thread 17 and a screwing imprint 18 on its proximal end face 13. The external thread 17 is adapted to be engaged in an internal thread 19 provided over at least part of the length L of the radial blind bore 8 of the radial fluids collecting chamber 6c (FIG. 4).

In the embodiment illustrated in FIG. 4, the filtration piece 7 is screwed into the radial fluids collecting chamber 6c until an intermediate section 21 abuts against a shoulder 20 of the radial fluids collecting chamber 6c. The intermediate section 21 has a height h chosen to maintain the chosen axial clearance j between the distal end face 10 of the filtration piece 7 and the back wall 60c of the radial blind bore 8 of the radial fluids collecting chamber 6c.

An O-ring seal 22 is provided at the periphery of the intermediate section 21 to be slightly compressed against the shoulder 20. The insertion of the filtration piece 7 into the radial fluids collecting chamber 6c is therefore limited not by compression of the O-ring seal 22 but by the intermediate section 21 abutting against the shoulder 20. The effect of this is to prevent deterioration of the O-ring seal 22 through excessive compression and through excessive shear forces.

As an alternative to using an intermediate section 21 abutting against the shoulder 20, it is possible to provide an indexed thread for the filtration piece 7 so that, at the end of screwing it in, the required axial clearance j is preserved between the distal end face 10 of the filtration piece 7 and the back wall 60c.

In the embodiment illustrated in FIG. 4, the filtration piece 7 is covered by an external body envelope 23. Demounting the filtration piece 7 can then necessitate the intervention of a qualified technician with the appropriate tools. For the manufacturer this guarantees that the hand held instrument is not dismantled and cleaned except by approved and sufficiently competent persons.

Alternatively, an opening 23a can be provided in the external body envelope 23 (represented in dashed lines) for accessing the filtration piece 7 and demounting it easily using only a screwdriver. This allows the user to maintain his hand held instrument for himself.

The step of demounting the filtration piece 7 and cleaning the radial fluids collecting chamber 6c is not always required, however, virtually all of the filtration being effected not in the radial fluids collecting chamber 6c but at its inlet. A simpler construction may therefore be preferred, like that shown in FIG. 2, in which the filtration piece 7 cannot be demounted, having been driven into the radial blind bore 8 of the radial fluids collecting chamber 6c, with the cylindrical proximal fixing section 12 a tight fit in the radial blind bore 8 of the radial fluids collecting chamber 6c.

The filtration pieces 7 illustrated in FIGS. 8 and 9 can be used as an alternative to the filtration piece 7 illustrated in FIGS. 3 and 5, and include a peripheral flange 24 with an outside diameter D4 substantially equal to the inside diameter D2 of the radial fluids collecting chamber 6c. These filtration pieces 7 also include a plurality of axial grooves 24a-24d provided at the periphery of the peripheral flange 24.

The outside diameter D4 of the peripheral flange 24 facilitates mounting the filtration piece 7 in the radial fluids collecting chamber 6c by ensuring perfect centering of the filtration piece 7.

Correct centering of the filtration piece 7 in the radial fluids collecting chamber 6c guarantees that the clearance is homogeneous all around the filtration piece 7, which improves filtration.

Depending on the size of the sections of the axial grooves 24a-24d, the latter can participate or not in the filtration of polluting particles in the fluid. Indeed, the fluid will have to pass through the axial grooves 24a-24d to enter completely into the radial fluids collecting chamber 6c and reach the downstream fluids conveying channel 6b.

To enable flow of the fluids from the upstream fluids conveying channel 6a to the downstream fluids conveying channel 6b, the filtration pieces 7 of FIGS. 8 and 9 will be mounted in the radial fluids collecting chamber 6c in the same manner as indicated in FIGS. 2 and 4, that is to say with an axial clearance j between the distal end face 10 of the filtration piece 7 and the back wall 60c of the radial blind bore 8 of the radial fluids collecting chamber 6c. The filtration piece 7 of FIG. 9 is intended to be used with the hand held dental instrument represented in FIGS. 1 and 2, while the filtration piece 7 of FIG. 8 is intended to be used with the hand held dental instrument represented in FIG. 4.

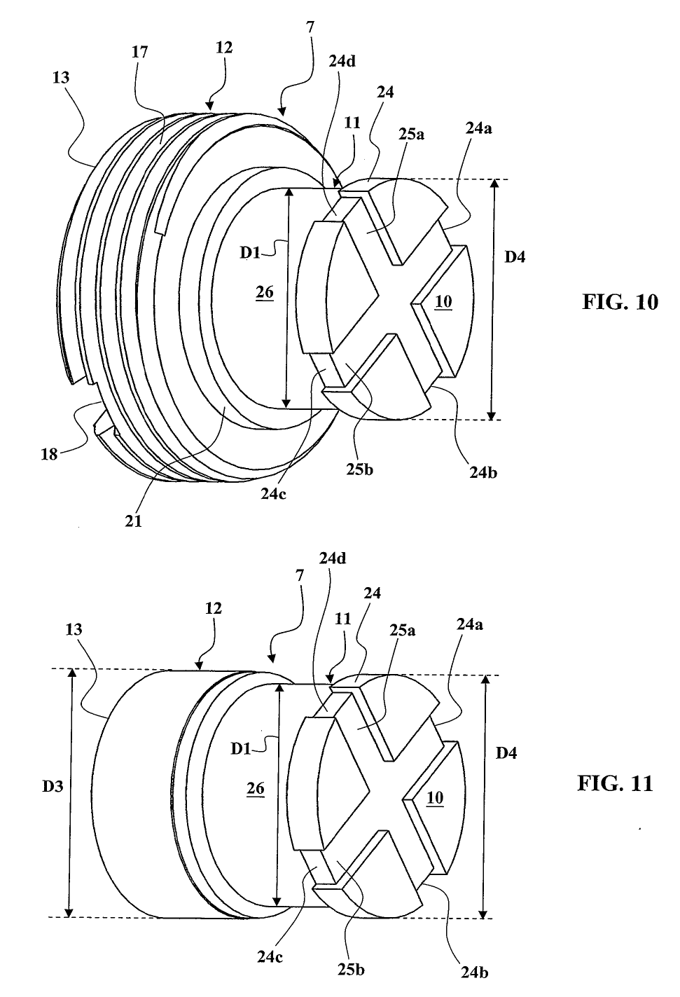

Other filtration pieces can still be used. The filtration pieces 7 of FIGS. 6 and 7 can be used, for example, the distal end face 10 whereof includes two grooves 25a and 25b opening onto the exterior wall 26 of the cylindrical distal filtration section 11. These filtration pieces 7 are intended to be fixed into the radial fluids collecting chamber 6c with the distal end face 10 abutted against the back wall 60c of the radial blind bore 8 of the radial fluids collecting chamber 6c. Thus it is no longer necessary to fix the filtration piece 7 into the radial fluids collecting chamber 6c with an axial clearance j between the distal end face 10 and the back wall 60c of the radial blind bore 8. The fluid will pass from the upstream fluids conveying channel 6a to the downstream fluids conveying channel 6b via the sections of the grooves 25a and 25b. Depending on the size of the sections of the grooves 25a and 25b, the latter can participate in the filtration of the fluid or not. The production of the grooves 25a and 25b proves simple and the dimensions can easily be controlled. The filtration piece 7 of FIG. 7 is intended to be used in the hand held dental instrument illustrated in FIGS. 1 and 2, while the filtration piece 7 illustrated in FIG. 6 is intended to be used in the hand held dental instrument illustrated in FIG. 4.

By combining features of the filtration pieces 7 of FIGS. 6 and 8, the choice may be made to use a filtration piece 7 of the type represented in FIG. 10. This includes on the one hand a peripheral flange 24 of diameter D4 substantially equal to the diameter D2 of the radial fluids collecting chamber 6c (FIGS. 2 and 4), with axial grooves 24a-24d. The filtration piece 7 also includes grooves 25a-25d produced on the distal end face 10 and opening onto the exterior wall 26 of the cylindrical distal filtration section 11. The cylindrical proximal fixing section 12 of this filtration piece 7 includes an external thread 17, while the proximal end face 13 includes a screwing imprint 18. The filtration piece 7 of FIG. 10 is intended to be inserted into the radial fluids collecting chamber 6c of the FIG. 4 embodiment of the hand held instrument. The filtration piece 7 is fixed into the latter with the distal end face 10 abutted against the back wall 60c of the radial blind bore 8 of the radial fluids collecting chamber 6c. To pass from the upstream fluids conveying channel 6a to the downstream fluids conveying channel 6b, the fluid passes through the grooves 25a and 25b and then the axial grooves 24a-24d at the periphery of the peripheral flange 24. The filtration properties of the filtration piece 7 of FIG. 10 are determined by the size of the sections of the grooves 25a and 25b and/or by the size of the sections of the axial grooves 24a-24d.

The filtration piece 7 of FIG. 10 is intended to be used in the embodiment of the hand held instrument illustrated in FIG. 4.

As for the filtration piece 7 of FIG. 11, the latter differs from that of FIG. 10 in that its cylindrical proximal fixing section 12 is intended to be a tight fit in the radial blind bore 8 of the radial fluids collecting chamber 6c when its distal end face 10 is abutted against the back wall 60c of the radial blind bore 8. The filtration piece 7 of FIG. 11 is thus intended to be used in the embodiment of the hand held instrument illustrated in FIGS. 1 and 2.

In all the embodiments of the hand held instrument illustrated in the figures, and whatever type of filtration piece 7 is used, it is found that filtering the fluids flowing in the body 1 does not increase its overall size at all.

The present invention is not limited to the embodiments that have been explicitly described, but includes diverse variants and generalizations thereof within the scope of the following claims.

1. Hand held dental instrument for carrying a working tool and driving it in relative movement, including:
a body (1) with a proximal end (1a) of the body (1) with an internal connecting bore (2) and a distal end (1b) of the body (1), adapted to be connected at its proximal end (1a) to driving means and to fluids feed means,
a head (3) connected to the distal end (1b) of the body (1), able to carry the working tool, and including means (5) for spraying fluids in the direction of the working area of the tool,
at least first fluids conveying means (6), for conveying the fluids through the body (1) from the proximal end (1a) of the body (1) and transmitting them to the fluids spraying means (5) of the head (3), including an upstream fluids conveying channel (6a), a downstream fluids conveying channel (6b), and a fluids collecting chamber (6c) in the body (1), between the upstream fluids conveying channel (6a) and the downstream fluids conveying channel (6b),
wherein:
the fluids collecting chamber (6c) is radial,
a filtration piece (7) is mounted in the radial fluids collecting chamber (6c) with a clearance to allow the passage of and to filter fluids between the upstream fluids conveying channel (6a) and the downstream fluids conveying channel (6b).

2. Hand held instrument according to claim 1, wherein:
the upstream fluids conveying channel (6a) extends radially from the internal connecting bore (2) of the body (1) to the radial fluids collecting chamber (6c),
the downstream fluids conveying channel (6b) extends from the radial fluids collecting chamber (6c) to the distal end (1b) of the body (1).

3. Hand held instrument according to claim 1, wherein the filtration piece (7) has an exterior shape substantially complementary to the interior shape of the radial fluids collecting chamber (6c).

4. Hand held instrument according to claim 3, wherein:
the radial fluids collecting chamber (6c) includes a circular section radial blind bore (8), produced in the body (1) and opening onto the exterior surface of the body (1), with a back wall (60c) terminating in the near vicinity of the internal connecting bore (2) of the body (1),
the upstream fluids conveying channel (6a) extends radially from the internal connecting bore (2) of the body (1) towards the back wall (60c) of the radial fluids collecting chamber (6c).

5. Hand held instrument according to claim 4, wherein:
the filtration piece (7) includes a distal end face (10) and a circular section cylindrical distal filtration section (11), the outside diameter (D1) of the cylindrical distal filtration section (11) being less than the inside diameter (D2) of the radial fluids collecting chamber (6c),
the filtration piece (7) includes a circular section cylindrical proximal fixing section (12) and with a proximal end face (13) the outside diameter (D3) of which is substantially equal to the inside diameter (D2) of the radial fluids collecting chamber (6c), intended to fix the filtration piece (7) in the radial fluids collecting chamber (6c) and to close the radial fluids collecting chamber (6c).

6. Hand held instrument according to claim 5, wherein, in the vicinity of its distal end face (10), the filtration piece (7) includes:
a peripheral flange (24) with an outside diameter (D4) substantially equal to the inside diameter (D2) of the radial fluids collecting chamber (6c),
at least one axial groove (24a-24d) provided at the periphery of the flange (24).

7. Hand held instrument according to claim 5, wherein the filtration piece (7) is fixed in the radial fluids collecting chamber (6c) with an axial clearance (j) between its distal end face (10) and the back wall (60c) of the radial blind bore (8) of the radial fluids collecting chamber (6c), the axial clearance (j) enabling passage of and filtering the fluids between the upstream fluids conveying channel (6a) and the downstream fluids conveying channel (6b).

8. Hand held instrument according to claim 5, wherein:
the distal end face (10) includes at least one groove (25a, 25b) opening onto the exterior wall (26) of the cylindrical distal filtration section (11),
the filtration piece (7) is fixed in the radial fluids collecting chamber (6c) with the distal end face (10) abutted against the back wall (60c) of the radial blind bore (8) of the radial fluids collecting chamber (6c).

9. Hand held instrument according to claim 5, wherein the filtration piece (7) is driven into the radial blind bore (8) of the radial fluids collecting chamber (6c) with the cylindrical proximal fixing section (12) of the filtration piece (7) a tight fit in the radial blind bore (8) of the radial fluids collecting chamber (6c).

10. Hand held instrument according to claim 5, wherein:
the radial blind bore (8) of the radial fluids collecting chamber (6c) includes an internal thread (19) over at least part of its length (L),
the cylindrical proximal fixing section (12) of the filtration piece (7) includes an external thread (17),
the proximal end face (13) of the cylindrical proximal fixing section (12) of the filtration piece (7) includes a screwing imprint (18).
